(19) United States
(12) Patent Application Publication
(10) Pub. No.: US 2026/0258660 A1
(43) Pub. Date: Sep. 3, 2026

(54) DECORATIVE PANEL AND METHOD FOR MANUFACTURING A DECORATIVE PANEL

(71) Applicant: UNILIN, BV, Wielsbeke (BE)

(72) Inventors: Benjamin CLEMENT, Waregem (BE); Jonas DEMAN, Sint-Amandsberg (BE); Laurent MEERSSEMAN, Mont de l'Enclus (BE); Christophe NAEYAERT, Jabbeke (BE); Martin SEGAERT, Ieper (BE); Bruno VERMEULEN, Aldeneik-Maaseik (BE)

(21) Appl. No.: 18/730,886

(22) PCT Filed: Jan. 26, 2023
(86) PCT No.: PCT/IB2023/050674

§ 371 Date: Jul. 22, 2024

Related U.S. Application Data
(60) Provisional application No. 63/303,595, filed on Jan. 27, 2022.

(51) Int. Cl. E04F 15/08; C08K 3/22; C08K 5/00; C08K 5/14; C08K 5/17; C08K 5/56; C08K 9/06; E04F 15/02

(52) U.S. Cl. CPC E04F 15/087; C08K 3/22; C08K 5/0033; C08K 5/14; C08K 5/17; C08K 5/56; C08K 9/06; E04F 15/02038; C08K 2003/2244; C08K 2201/003; C08K 2201/004

(57) ABSTRACT

A decorative panel includes a substrate and a decorative surface. The substrate includes a copolymer selected from the group consisting of a copolymer of an unsaturated polyester, an acrylic copolymer, a vinyl ester copolymer, an epoxy copolymer, a polyurethane copolymer, or combinations thereof.

The present invention is disclosed in the claims and relates to decorative panels and a method for manufacturing decorative panels. The invention is in the first place aiming at floor panels, but may be put to practice with wall panels, ceiling panels or furniture panels as well.

More particularly, the invention relates to floor panels of the type which is at least composed of a substrate and a decorative surface, for example a top layer provided on this substrate, wherein said top layer comprises a motif. Above said motif a transparent or translucent synthetic material layer may be provided, which layer then forms part of said top layer.

In particular, the present invention relates to floor panels of the type which, at two or more opposite edges, may comprise coupling means or coupling parts, with which two of such floor panels can be coupled at the respective edges, such that they are locked together in a horizontal direction perpendicular to the respective edge and in the plane of the floor panels, as well as in a vertical direction perpendicular to the plane of the floor panels. Such floor panels can be applied for composing a so-called floating floor covering, wherein the floor panels are interconnected at their edges, however, are lying freely on the underlying floor.

From WO 97/47834 and EP 1 290 290, laminate floor panels are known for forming a floating floor covering. However, laminate floor panels show the disadvantage that they mostly are provided with a moisture-sensitive substrate, namely MDF or HDF (Medium Density Fiberboard or High Density Fiberboard), and that the top layer provided on said substrate, when the floor covering is in use, leads to the development of ticking noises. Furthermore, the panels of WO'834 are subject to dimensional changes with a changing ambient relative humidity, necessitating the use of expansion profiles and the likes to cover required expansion gaps, which takes away from the aesthetic pleasure and introduces safety hazards. From EP 1 290 290, it is known to provide laminate floor panels with a structured surface, for example, with a structure imitating wood pores.

From EP 1 938 963, vinyl-based floor panels are known for forming such floating floor covering. Such vinyl-based floor panels mostly have a thickness of 3 to 5 millimeters and have a high material density. Inherent to these floor panels is their limited bending stiffness and their high deformability. These features lead to problems when the floor panels are applied on an uneven underlying surface. Namely, after a certain period of time the unevenness of the underlying surface may migrate to the surface of the floor covering. With a local load, for example, underneath the legs of tables or chairs, permanent impressions will occur, which are undesired as well. The floor panels of EP 1 938 963 require the presence of plasticizers in the soft PVC core, which may lead to environmental issues and safety hazards. Since, over time, the use of certain plasticizers and other additives in PVC has been forbidden, the recycling of old PVC materials is far from straightforward, since such PVC scrap may contain chemicals that in the meantime have been legally forbidden for use. The halogen content in the PVC is often in itself seen as a source of pollution, for example when such material would be burnt at the end of its lifecycle.

WO 2011/141,849 and WO 2014/117,887 disclose decorative panels having a foamed core. In accordance with WO 2011/141,849 a higher bending stiffness, and an enhanced resistance against migration of underlying surface unevennesses is obtained. In accordance with WO'887 the foamed core is plasticizer free, and may be based on a substituted or unsubstituted polyolefin thermoplastic material. WO 2017/122149 discloses decorative panels having a core comprising thermoplastic polyester and elastomer.

Decorative panels based on unsubstituted polyolefins, substituted polyolefins, such as polyvinyl chloride (PVC), or on thermoplastic polyesters such as polyethylene terephthalate comprise a substrate material that is better resistant against water, and leads to a better accepted noise development in use than the panels of WO'834. Such panels are however also subject to dimensional changes, however, mostly caused by a changing ambient temperature. In contrast to the ambient relative humidity, the ambient temperature may be significantly less uniformly distributed over a surface that is covered with panels. The dimensional changes may lead to localized expansion phenomena, for example where sunlight directly falls on the covering, i.e. at a so-called “hot spot”. The covering may rise locally at the hot spot and form a bubble and/or the joints may locally deform upwardly and peak out of the covered surface.

Some solutions to the thermal expansion of thermoplastic panels are proposed in WO 2016/001859, such as the incorporation of glass fiber textiles and/or filler materials. Technically and economically speaking, the possibilities to stabilize thermoplastic materials are limited. An introduction of a high amount of filler materials in thermoplastic materials for example leads to brittleness, making it hard to realize trustworthy mechanical coupling means in such materials.

The present invention relates to an alternative decorative panel, which in particular is intended as a floor panel for forming a floating floor covering. According to various preferred embodiments of the invention, also a solution is offered for one or more problems with the floor panels of the state of the art. In particular, the inventors have found that one or more copolymers may be used to form at least a part of the substrate of a floor panel, wherein the floor panel is better resistant against water, has an improved dimensional stability, and shows a significantly lower brittleness when compared to floor panels of the state of the art.

The aspects or concepts of the present invention are further illustrated in a non-limiting manner in the following paragraphs.

A first aspect of the invention relates to a decorative panel comprising a substrate and a decorative surface, wherein said substrate comprises a copolymer selected from the group consisting of a copolymer of an unsaturated polyester, an acrylic copolymer, a vinyl ester copolymer, an epoxy copolymer, a polyurethane copolymer, or combinations thereof.

The copolymer may be a copolymer of an unsaturated polyester and a vinyl monomer, in particular a copolymer of an unsaturated polyester and styrene. More in particular, the unsaturated polyester may be a dicyclopentadiene resin or may be selected from the group consisting of a resin containing primarily terephthalic acid, a resin containing primarily phthalic anhydride, and a resin containing primarily isophthalic acid. Suitable foaming agents to be applied may be triethanolamine-azodiisobutyronitrile mixture, azodicarbonamide, sodium bicarbonate, ammonium bicarbonate, or combinations thereof.

The copolymer may also be an acrylic copolymer, in particular a copolymer of at least two acrylic compounds. More in particular, the at least two acrylic compounds are selected from the group consisting of methyl acrylate, methyl methacrylate, polymethyl methacrylate, ethylene glycol dimethacrylate, or combinations thereof. Acrylics are abundantly available on the market and have the advantage to not show any yellowing upon exposure to sunlight. Suitable initiators may be benzoyl peroxide or methyl ethyl ketone peroxide. Suitable activators may be tertiary amines, such as N,N′-dimethyl-p-toluidine. The acrylics may usually be dissolved in methyl methacrylate.

The copolymer may also be a vinyl ester copolymer, in particular a vinyl ester copolymer of a diepoxide and acrylic acid or methacrylic acid. More in particular, this diepoxide may be a diglycidyl ether of bisphenol A.

The copolymer may also be an epoxy copolymer, in particular an epoxy copolymer of a diepoxide and a tertiary (di)amine. More in particular, the diepoxide may be selected from the group consisting of a diglycidyl ether of bisphenol A, a diglycidyl ether of bisphenol F, or combinations thereof. The tertiary (di)amine may be isophorone diamine or a derivative thereof.

The copolymer may also be a polyurethane copolymer, in particular a polyurethane copolymer of a polyol and an isocyanate. More in particular, the polyol may be ethylene glycol. The isocyanate may be methylene diphenyl diisocyanate.

The substrate may further comprise at least 3 weight parts filler materials per part of the copolymer. It may be possible that the substrate comprises at least 4, 5, 6, 7, 8, 9, or 10 weight parts filler materials per part of the copolymer. Fillers may comprise barium sulphate, calcium carbonate, quartz, chalk, expanded glass, cement, or combinations thereof.

The substrate may further comprise at least 5 wt. %, preferably 5 to 25 wt. %, reinforcement fibers. In particular, the reinforcement fibers may show one or a combination of two or more of the following properties:
the property that said reinforcement fibers are chosen from the list consisting of glass fibers, rock fibers, basalt fibers, polyvinyl alcohol fibers, copolymer fibers, steel fibers, aramid fibers, polyethylene fibers and carbon fibers;
the property that said reinforcement fibers have a tensile strength above 2500 MPa and/or a Young's modulus of more than 40, still better of more than 60 GPa;
the property that said reinforcement fibers have an average length of 1 mm or more; and/or the property that said reinforcement fibers have a diameter situated between 1 and 100 micrometers or still better between 3 and 30 micrometers.

It was found by the inventors that dimensional stability was further improved by combining the copolymer material and the reinforcement fibers showing any of the aforementioned properties. The reinforcement fibers may further be coated with an adherence promotor, preferably a silane-based compound.

The decorative surface as described herein may comprise a printed carrier sheet selected from a printed paper sheet, a printed PVC film, a printed PP film, a printed PE film, a printed PET film, a printed PETG film. The decorative surface may also comprise a low temperature glaze, or a curable acrylic resin. The decorative surface may also comprise a stone veneer layer.

The substrate may further comprises one or more core elements said core elements comprise a material selected from the group consisting of stone slabs, ceramics slabs, magnesium oxide based slabs, foamed polymer slabs, or combinations thereof. By choosing a specific core element, the substrate may be provided with further characteristics like increased or decreased weight, higher strength, and the like.

The decorative panel may also be provided at two or more opposite edges, with coupling means or coupling parts, with which two of such decorative panels can be coupled at the respective edges, such that they are locked together in a horizontal direction perpendicular to the respective edge and in the plane of the decorative panels, as well as in a vertical direction perpendicular to the plane of the decorative panels.

A second aspect of the invention relates to a method for manufacturing a decorative panel, wherein said decorative panel comprises a substrate and a decorative surface, wherein said method comprises at least the step of providing a substrate comprising a copolymer selected from the group consisting of a copolymer of an unsaturated polyester, an acrylic copolymer, a vinyl ester copolymer, an epoxy copolymer, a polyurethane copolymer, or combinations thereof.

The copolymer may be a copolymer of an unsaturated polyester, wherein said step of providing a substrate comprises
providing a mixture by mixing an unsaturated polyester, preferably selected from the group consisting of a dicyclopentadiene resin, a resin containing primarily terephthalic acid, a resin containing primarily phthalic anhydride, and a resin containing primarily isophthalic acid, with at least a vinyl monomer, preferably styrene; and
shaping and curing said mixture into at least a part of said substrate.

According to some embodiments, the unsaturated polyester may be made on the basis of an alcohol chosen from the group of propylene glycol, ethylene glycol, dipropylene glycol, diethylene glycol, neopentylglycol, or combinations thereof. By preference, said alcohol may be propylene or ethylene glycol. According to some embodiments, said alcohol may be dipropylene glycol, diethylene glycol or neopentylglycol. Using one of the latter alcohols as a basis for the unsaturated polyester may yield a material which may have higher flexibility. Most by preference, said alcohol may be diethylene glycol.

According to some embodiments, said vinyl monomer may be styrene or para-methyl styrene. According to a particularly preferred embodiment, said vinyl monomer may be para-methyl styrene. According to some embodiments, said vinyl monomer may be chosen from the group of acrylates and/or methacrylates. By preference, said vinyl monomer may be chosen from the group of methyl methacrylate, butyl methacrylate, trimethylol propane triacrylate (TMPTA), or combinations thereof. According to some embodiments, an anti-shrink component may be present, such as polystyrene.

According to some embodiments, said unsaturated polyester and said vinyl monomer may be present in said mixture following a ratio of between 10:5 and 5:10, preferably of between 10:8 and 8:10, more preferably of between 10:9 and 9:10, such as about 10:10.

The mixture may further comprise an initiator compound, preferably 0.1 to 10 wt. % of a metal salt, more preferably a transition metal salt, and/or 0.1 to 10 wt. % of an organic peroxide, more preferably benzoyl peroxide or methyl ethyl ketone peroxide, and/or 0.1 to 10 wt. % of cobalt octonate, and/or 0.1 to 10 wt. % of tert-Butyl peroxybenzoate (TBPB). The mixture may also further comprise a foaming agent, preferably 0.1 to 10 wt. % of a foaming agent selected from the group consisting of an triethanolamine-azodiisobutyronitrile mixture, azodicarbonamide, sodium bicarbonate, ammonium bicarbonate, or combinations thereof.

The copolymer may also be an acrylic copolymer, wherein said step of providing a substrate comprises
providing a mixture by mixing at least two acrylic compounds, preferably selected from the group consisting of methyl acrylate, methyl methacrylate, polymethyl methacrylate, ethylene glycol dimethacrylate, or combinations thereof; and
shaping and curing said mixture into at least a part of said substrate.

The mixture may further comprise an initiator compound, preferably 0.1 to 10 wt. % of an organic peroxide, more preferably benzoyl peroxide or methyl ethyl ketone peroxide, and/or 0.1 to 10 wt. % of cobalt octonate. The mixture may also further comprise an activator compound, preferably 0.1 to 10 wt. % of a tertiary amine, more preferably N,N′-dimethyl-p-toluidine. The mixture may also further comprises a coupling agent, preferably 0.1 to 10 wt. % of a silane and/or 0.1 to 10 wt. % of a zirconate. These may provide for a better adherence with potential fillers, such as barium sulphate, calcium carbonate, quartz and the like.

The copolymer may also be a vinyl ester copolymer, wherein said step of providing a substrate comprises
providing a mixture by mixing a diepoxide, preferably a diglycidyl ether of bisphenol A, and at least an acrylic acid or methacrylic acid; and
shaping and curing said mixture into at least a part of said substrate.

The mixture may further comprise a catalyst, preferably 0.1 to 10 wt. % of one or more chelates of chromium. These chelates are exemplified as the AMC-2 compound referred to in the above example.

The copolymer may also be an epoxy copolymer, wherein said step of providing a substrate comprises
providing a mixture by mixing a diepoxide, preferably selected from the group consisting of a diglycidyl ether of bisphenol A, a diglycidyl ether of bisphenol F, or combinations thereof, and at least a tertiary (di)amine, preferably isophorone diamine or a derivative thereof; and
shaping and curing said mixture into at least a part of said substrate.

The copolymer may also be a polyurethane copolymer, wherein said step of providing a substrate comprises
providing a mixture by mixing a polyol, preferably ethylene glycol, and at least an isocyanate, preferably methylene diphenyl diisocyanate; and
shaping and curing said mixture into at least a part of said substrate.

The mixture may also comprise a catalyst, preferably 0.1 to 10 wt. % of an amine, more preferably triethylenediamine, dimethylethanolamine, N, N-dimethylcyclohexylamine, or combinations thereof.

Further suitable copolymers may comprise copolymers of acrylic compounds and methacrylic compounds, of acrylic compounds and unsaturated polyester compounds, of phenolic resins and acrylic compounds, or of phenolic resins and unsaturated polyester compounds.

The substrate may further comprise at least 3 weight parts filler materials per part of the copolymer. It may be possible that the substrate comprises at least 4, 5, 6, 7, 8, 9, or 10 weight parts filler materials per part of the copolymer.

The substrate may further comprise at least 5 wt. %, preferably 5 to 25 wt. %, reinforcement fibers. In particular, the reinforcement fibers may show one or a combination of two or more of the following properties:
the property that said reinforcement fibers are chosen from the list consisting of glass fibers, rock fibers, basalt fibers, polyvinyl alcohol fibers, copolymer fibers, steel fibers, aramid fibers, polyethylene fibers and carbon fibers;
the property that said reinforcement fibers have a tensile strength above 2500 MPa and/or a Young's modulus of more than 40, still better of more than 60 GPa;
the property that said reinforcement fibers have an average length of 1 mm or more; and/or
the property that said reinforcement fibers have a diameter situated between 1 and 100 micrometers or still better between 3 and 30 micrometers.

It was found by the inventors that dimensional stability was further improved by combining the copolymer material and the reinforcement fibers showing any of the aforementioned properties. The reinforcement fibers may further be coated with an adherence promotor, preferably a silane-based compound.

The decorative surface as described herein may comprise a printed carrier sheet selected from a printed paper sheet, a printed PVC film, a printed PP film, a printed PE film, a printed PET film, a printed PETG film.

Shaping and curing any of the aforementioned mixture may comprise pressing said mixture at a pressure of 1 MPa or above. Shaping and curing any of these mixture may also comprises heating said mixture to a temperature of 80° C. or above. It may however be possible that curing is already achieved upon heating to a temperature of above 50° C., 60° C., or 70° C. Shaping and curing said mixture may comprise forming said part of said substrate to have a board shape with a decorative relief in at least one of the major surfaces of said board. The method as described herein may also further comprise the step of providing a decorative surface to said substrate. In particular, the step of providing a decorative surface may comprise applying a printed carrier sheet selected from a printed paper sheet, a printed PVC film, a printed PP film, a printed PE film, a printed PET film, or a printed PETG film.

It may be that shaping and curing said mixture comprises extruding said mixture. Such an extrusion process is exemplified in the following drawing.

The mixture before and/or during extruding may be kept below a curing temperature of the mixture, preferably at a temperature of below 80° C. It may be possible that the temperature is kept below 70° C., 60° C. or even 50° C. It may also be that the mixture is heated to above said curing temperature, preferably to a temperature of above 80° C. It may be possible that this temperature is above 70° C., above 60° C. or above 50° C. By controlling the temperature as described, the mixture can move efficiently through the extruder, wherein curing is not started, by heating after the mixture has left the extruder, curing is initiated.

It may also be possible that curing occurs through a two-step heating. Herein, it may be possible that the mixture has a first and a second curing temperature, and wherein said mixture before and/or during extruding is kept below said first and said second curing temperature, preferably at a temperature of below 80° C. It may be possible that the temperature is kept below 70° C., 60° C. or even 50° C. It may also be possible that the mixture after extruding is heated to above said first curing temperature, preferably to a temperature of above 80° C., and consequently said mixture is further heated to above said second curing temperature, preferably to a temperature of above 150° C. By heating following this two-step process, the mixture can move efficiently through the extruder, wherein curing is not started, by heating after the mixture has left the extruder, a first curing step is initiated. Hereafter, the mixture is partly cured. It may be that the mixture does not move freely anymore, but however remains pliable and/or workable. By applying the second curing step, the mixture is permanently cured to its solid form.

The mixture after extruding may be heated by a heating device, said heating device has a temperature of between 150 and 160° C., preferably during at least 90 seconds. As such the mixture can be heated to obtain an optimal (curing) temperature inside the core of the mixture. Such heating device may be a heated continuous press device, preferably a double steel belt press. Such heating device may also be an infrared heating device or an oven.

The method may further comprise the step of embossing said substrate and/or said decorative surface. The step of embossing said substrate and/or said decorative surface may be performed before heating said mixture to above said curing temperature. The step of embossing said substrate and/or said decorative surface may also be performed after heating said mixture to above said first curing temperature, and before heating said mixture to above said second curing temperature.

Extruding said mixture may be done through a compacter-type and/or compounder-type extruder. The mixture may furthermore be extruded through a T-die.

The step of shaping and curing the mixture may also comprises introducing said mixture inside a mold, wherein said mixture is cured inside said mold. It may be that the mixture has a curing temperature, wherein shaping and curing said mixture comprises heating said mixture to above said curing temperature, preferably to a temperature of above 80° C. Temperatures of above 70° C., above 60° C., or above 50° C. may also be possible. It may be that the mixture has a first and a second curing temperature, wherein shaping and curing said mixture comprises heating said mixture to above said first curing temperature, preferably to a temperature of above 80° C., and consequently said mixture is further heated to above said second curing temperature, preferably to a temperature of above 150° C.

The method may further comprise the step of introducing a decorative surface inside said mold. In particular, the decorative surface may introduced before pressing and/or heating said mixture. More in particular, the decorative surface may be introduced before heating said mixture to above said curing temperature. By introducing the decorative surface before curing, good adherence between the decorative surface and the substrate may be obtained. It may also be possible that the decorative surface is introduced after heating said mixture to above said first curing temperature, and before heating said mixture to above said second curing temperature. As such the risk of the decorative surface breaking or tearing upon applying pressure and/or heat may be minimized, by only doing so when the mixture is already partly cured. It may be that the decorative surface is provided with a predisposed embossment structure. As such, no separate embossment step may be needed.

It may also be possible that the method further comprises the step of embossing said substrate and/or said decorative surface, preferably through an embossing structure provided inside said mold. In particular, the embossing structure provided inside said mold may comprise a microstructure for improving adherence between the substrate and the decorative surface. This may be a viable alternative to sanding the substrate, which may alternatively be done to improve adherence between the substrate and the decorative surface.

The configuration of the substrate and the decorative surface inside the mold may be different. In particular, the mold may comprise an upper mold half and a lower mold half, wherein said decorative surface is introduced into said mold before said mixture is introduced into said mold, the decorative surface being located on the side of the lower mold half. It may also be possible that the decorative surface is introduced into said mold after said mixture is introduced into said mold, the decorative surface being located on the side of the upper mold half.

In particular, the decorative surface may comprise a low temperature glaze, or a curable acrylic resin. Or the decorative surface may also comprise a stone veneer layer. These alternative decorative surface may provide the decorative panel with distinguishing looks, e.g. marble, stone or ceramics imiations.

The method may also further comprise the step of introducing one or more core elements inside said mold, said core elements comprise a material selected from the group consisting of stone slabs, ceramics slabs, magnesium oxide based slabs, foamed polymer slabs, or combinations thereof. In particular, the following subsequent steps may be present
providing a mixture by mixing an unsaturated polyester, preferably selected from the group consisting of a dicyclopentadiene resin, a resin containing primarily terephthalic acid, a resin containing primarily phthalic anhydride, and a resin containing primarily isophthalic acid, with at least a vinyl monomer, preferably styrene;
introducing said decorative surface inside said mold;
introducing a first part of said mixture inside said mold;
introducing said core elements inside said mold;
introducing a second part of said mixture inside said mold;
shaping and curing said mixture into at least a part of said substrate.

More in particular, said mold may be comprised in an opening and closing press.

It may also be possible that extrusion and molding are combined alike, wherein the mixture is extruded and the extruded mixture is subsequently brought into a mold. Herein one or both curing steps as described may take place after the extruder, a first step could take place before the mold and a second step inside the mold, or both steps could take place inside the mold.

It may also be possible that the shaping and curing said mixture comprises depositing, for example by means of one or more scattering stations, said mixture on a conveying means and compressing said mixture by means of a continuously operated press, for example between the belts of a steel belt press. This particular embodiment thus constitutes a scattering method for manufacturing the decorative panel as described herein. The mixture may comprises at least two different colors and/or hues, wherein curing said mixture provides the substrate with a decorative motif. It may be possible to apply certain fillers, such as chalk, to improve the flowability of the mixture, and thus to allow better scattering.

Another possibility may include casting (pouring) the copolymer mixture directly on a double band press, wherein flowability may be controlled by limiting the amount of fillers. Such a double band press may be provided with a heating and cooling zone to allow efficient curing. Yet another possibility may include directly pressing a plurality of layers impregnated with the copolymer mixture. Such layers may comprise paper layers, glass fiber layers or the like. Impregnability may be controlled by limiting the amount of fillers.

Combinations of any of the above methodologies may be possible, for example a substrate layer could be manufactured by means of extrusion, scattering or casting, while a top and/or bottom layer are provided by means of an impregnated layer which is compressed onto the substrate.

The method may also further comprise the step of providing the substrate at two or more opposite edges, with coupling means or coupling parts, with which two of such decorative panels can be coupled at the respective edges, such that they are locked together in a horizontal direction perpendicular to the respective edge and in the plane of the decorative panels, as well as in a vertical direction perpendicular to the plane of the decorative panels.

A third aspect concerns a decorative panel comprising a substrate and a decorative surface, wherein said decorative surface comprises a copolymer selected from the group consisting of a copolymer of an unsaturated polyester, an acrylic copolymer, a vinyl ester copolymer, an epoxy copolymer, a polyurethane copolymer, or combinations thereof. The copolymer composition thus may constitute the decorative surface instead of the substrate. A decorative panel with high scratch resistance, high rigidity and/or dimensional stability may be obtained, although comprising alternative substrate materials.

The copolymer may be a copolymer of an unsaturated polyester and a vinyl monomer, in particular a copolymer of an unsaturated polyester and styrene. More in particular, the unsaturated polyester may be a dicyclopentadiene resin or may be selected from the group consisting of a resin containing primarily terephthalic acid, a resin containing primarily phthalic anhydride, and a resin containing primarily isophthalic acid. Suitable foaming agents to be applied may be triethanolamine-azodiisobutyronitrile mixture, azodicarbonamide, sodium bicarbonate, ammonium bicarbonate, or combinations thereof.

The copolymer may also be an acrylic copolymer, in particular a copolymer of at least two acrylic compounds. More in particular, the at least two acrylic compounds are selected from the group consisting of methyl acrylate, methyl methacrylate, polymethyl methacrylate, ethylene glycol dimethacrylate, or combinations thereof. Acrylics are abundantly available on the market and have the advantage to not show any yellowing upon exposure to sunlight. Suitable initiators may be benzoyl peroxide or methyl ethyl ketone peroxide. Suitable activators may be tertiary amines, such as N,N′-dimethyl-p-toluidine. The acrylics may usually be dissolved in methyl methacrylate.

The copolymer may also be a vinyl ester copolymer, in particular a vinyl ester copolymer of a diepoxide and acrylic acid or methacrylic acid. More in particular, this diepoxide may be a diglycidyl ether of bisphenol A.

The copolymer may also be an epoxy copolymer, in particular an epoxy copolymer of a diepoxide and a tertiary (di)amine. More in particular, the diepoxide may be selected from the group consisting of a diglycidyl ether of bisphenol A, a diglycidyl ether of bisphenol F, or combinations thereof. The tertiary (di)amine may be isophorone diamine or a derivative thereof.

The copolymer may also be a polyurethane copolymer, in particular a polyurethane copolymer of a polyol and an isocyanate. More in particular, the polyol may be ethylene glycol. The isocyanate may be methylene diphenyl diisocyanate.

The substrate may further comprise at least 3 weight parts filler materials per part of the copolymer. It may be possible that the substrate comprises at least 4, 5, 6, 7, 8, 9, or 10 weight parts filler materials per part of the copolymer.

The substrate may further comprise at least 5 wt. %, preferably 5 to 25 wt. %, reinforcement fibers. In particular, the reinforcement fibers may show one or a combination of two or more of the following properties:
the property that said reinforcement fibers are chosen from the list consisting of glass fibers, rock fibers, basalt fibers, polyvinyl alcohol fibers, copolymer fibers, steel fibers, aramid fibers, polyethylene fibers and carbon fibers;
the property that said reinforcement fibers have a tensile strength above 2500 MPa and/or a Young's modulus of more than 40, still better of more than 60 GPa;
the property that said reinforcement fibers have an average length of 1 mm or more; and/or
the property that said reinforcement fibers have a diameter situated between 1 and 100 micrometers or still better between 3 and 30 micrometers.

It was found by the inventors that dimensional stability was further improved by combining the copolymer material and the reinforcement fibers showing any of the aforementioned properties. The reinforcement fibers may further be coated with an adherence promotor, preferably a silane-based compound.

The substrate of the decorative panel may comprise an HDF or MDF material. It may also be possible that the substrate comprises a thermoplastic material. In particular, said thermoplastic material may be polyethylene terephthalate (PET). It may also be possible that said thermoplastic material further comprises reinforcement fibers, preferably copolymer-based reinforcement fibers. The decorative panel may also further comprise a back layer, wherein said back layer comprises the same copolymer material of the decorative surface.

The copolymer material as described herein may be thus be obtained by using methods as described in the second aspect, however the copolymer material constitutes the decorative surface instead of the substrate. To obtain sufficiently thin layers of copolymer material, it may be possible that the copolymer material is sliced into thinner layers.

In order to better demonstrate the features of the invention, some preferred embodiments are described below, by way of example and without any limiting character, with reference to the accompanying drawings, wherein:

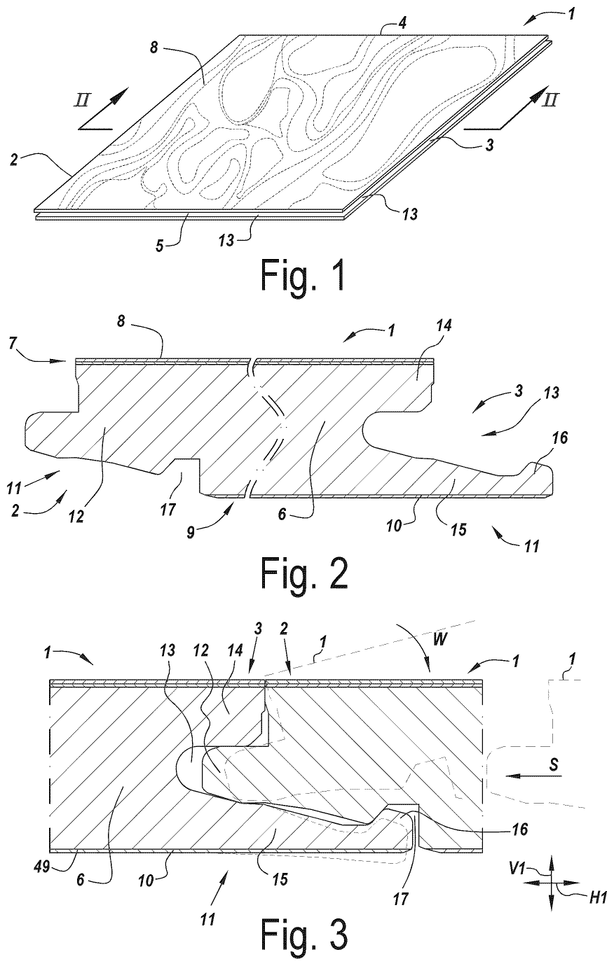

FIG. 1 in a perspective view shows a decorative panel in accordance with the invention;

FIG. 2 at a larger scale shows a cross-section in accordance with the line II-II of FIG. 1;

FIG. 3 in a similar view shows the connection between two such panels;

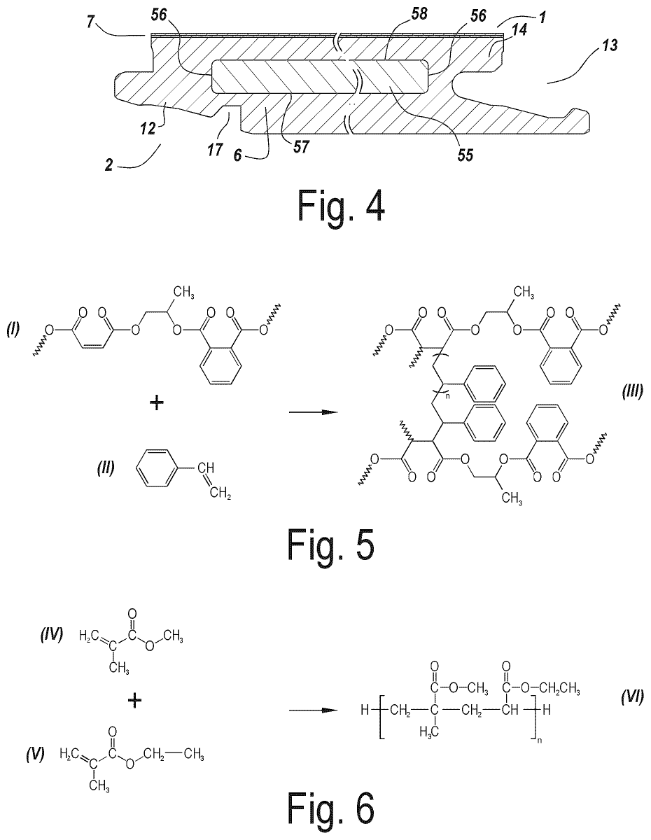

FIG. 4 in a similar view as FIG. 2, shows a variant of a decorative panel in accordance with the invention;

FIG. 5 schematically shows some steps in a method for manufacturing a decorative panel according to the second aspect of the invention;

FIGS. 6 to 14 show variants; and

FIG. 15 illustrates some steps in a method for manufacturing a decorative panel according to the second aspect of the invention.

FIG. 1 shows a decorative panel 1 in accordance with the invention. The decorative panel 1 has a square or near square shape with two pairs of opposite edges 2-3-4-5. In accordance with a variant, the decorative panel 1 may be rectangular and oblong with a pair of opposite long edges and a pair of opposite short edges.

FIG. 2 clearly shows that the panel 1 comprises a substrate 6 and, in this case, a top layer 7 forming a decorative surface 8. At the bottom 9 of the panel 1, in particular on the bottom surface 49, a backing layer 10 is provided as well.

The panel 1 is at least at two opposite edges 2-3 provided with coupling means or coupling parts 11, with which two of such floor panels 1 can be coupled at the respective edges 2-3. In the non-represented example of a rectangular and oblong panel these may for example be at least the long pair of opposite edges. Preferably the panel 1 is provided at the edges of both pairs of opposite edges 2-3-4-5 with coupling parts 11, either of the same type of different type.

As shown in FIG. 3, two such panels 1 may become locked together in a horizontal direction H1 perpendicular to the respective edges 2-3 and in the plane of the floor panels 1, as well as in a vertical direction V1 perpendicular to the plane of the floor panels 1. It is clear that such floor panels 1 can be applied for composing a so-called floating floor covering, wherein the floor panels 1 are interconnected at their edges, however, are lying freely on the underlying floor.

In the represented example, the coupling parts 11 provided at said two opposite edges 2-3 are basically shaped as a tongue 12 at one edge 2 and a groove 13 at an opposite edge 3. The groove is delimited by an upper lip 14 and a lower lip 15. The tongue 12 and groove 13 are essentially responsible for said locking in said vertical direction V1. The tongue 12 and groove 13 further comprise locking means preventing the drifting apart of the tongue 12 and the groove 13, when in coupled condition. The locking means comprise a protrusion 16 on the upper side of the lower lip for cooperation with an excavation 17 at the bottom of the tongue 12. The represented coupling means 11 allow the panels 1 to become connected to each other at the respective edges 2-3 by means of a turning motion W of one panel 1 relative to the other, as well as by means of a shifting motion S in a substantially horizontal fashion of one panel 1 towards the other.

The particularity of the panel 1 in accordance with the present invention is that the substrate 6, in this case a single layered substrate, comprises a copolymer selected from the group consisting of a copolymer of an unsaturated polyester, an acrylic copolymer, a vinyl ester copolymer, an epoxy copolymer, a polyurethane copolymer, or combinations thereof. In the example, the substrate is single-layered and formed of a synthetic composite material comprising said copolymer, filler materials and reinforcement fibers.

FIG. 3 shows that the material of the substrate 6 allows for a flexibility of one or more portions of the coupling parts 11, in this case at least the lower groove lip 15, as shown by means of the dashed line 18. The lower groove lip 15 flexes and returns towards its original position upon performing said turning movement W or shifting movement S. In a coupled condition the lower groove lip 15 may not have been returned completely to its original position, but, on the contrary may remain bent out, for example over a small distance, i.e. several hundredths of a millimeter. In so doing, the lower lip 15 may at the location of the contact between said locking means, i.e. between the protrusion 16 and the excavation 17, actively push upon the lower side of the tongue 12 and force the tongue 12 in a more tight engagement with said groove 13, wherein for example the width of a possible seam at the joint between the flooring panels 1 could be limited. Such action of the lower lip 15 is known per se as “pretension” and is disclosed e.g. in WO '97/47834.

FIG. 4 shows a panel comprising the one or more core elements as described above. A decorative panel is shown, wherein the substrate 6 of the decorative panel 1 contains an one or more core elements 55 that is in at least two orthogonal directions adjacent to said copolymer or synthetic composite. The core element 55 has a rectangular prism shape that is at least at both edges of a pair of two opposite small edges 56 adjacent to said copolymer. As shown, the core element 55 may be completely surrounded by said copolymer or synthetic composite in that it is adjacent to said copolymer at both edges of the other pair of two opposite small edges, at its bottom surface 57 and at its top surface 58, as well.

FIG. 5 schematically illustrates some steps in a method for manufacturing a decorative panel according to the second aspect of the invention. FIGS. 6-14 show variants. In particular, FIGS. 5 to 14 illustrate reaction mechanisms and/or reaction mixtures which may be used in some steps of the method of the invention.

FIG. 5 illustrates a reaction mechanism for forming a copolymer of an unsaturated polyester. In particular, an unsaturated polyester according to formula (I) is mixed with styrene according to formula (II) which, in the presence of a peroxide, forms a cured copolymer according to formula (III).

FIG. 6 illustrates a reaction mechanism for forming an acrylic copolymer from an acrylic mixture. In particular, methyl methacrylate according to formula (IV) is mixed with ethyl methacrylate according to formula (V) which, in the presence of heat and an initiator, forms a cured copolymer according to formula (VI).

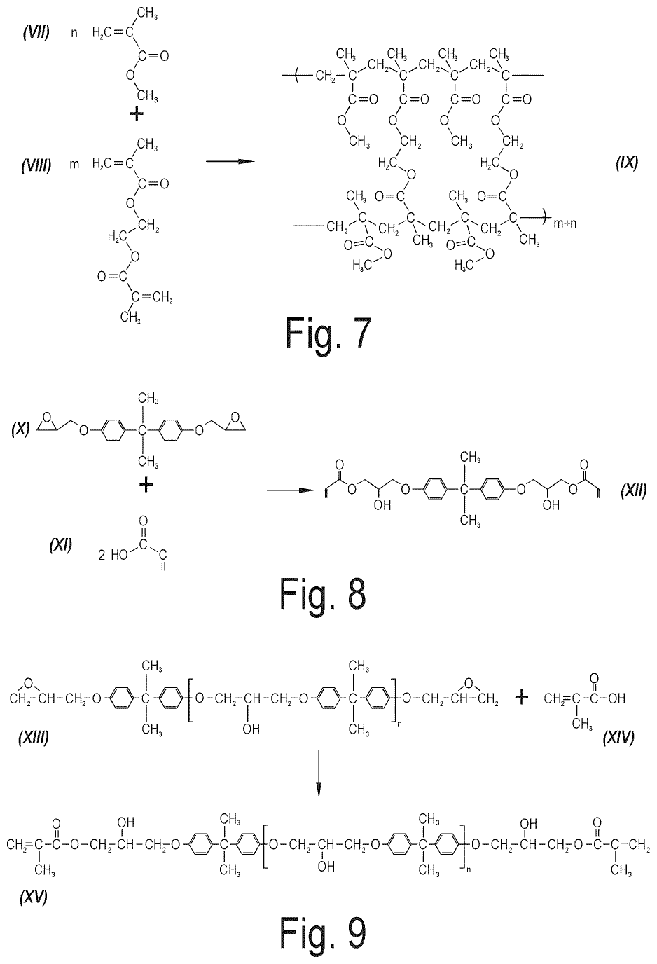

FIG. 7 illustrates a reaction mechanism for forming a copolymer from an acrylic mixture. In particular, methyl methacrylate according to formula (VII) is mixed with ethylene glycol dimethacrylate according to formula (VIII) which forms a crosslinked methacrylate copolymer according to formula (IX).

FIG. 8 illustrates a reaction mechanism for forming a vinyl ester copolymer. In particular, a diepoxide according to formula (X) is mixed with an acrylic acid according to formula (XI) which forms a vinyl ester copolymer according to formula (XII).

FIG. 9 illustrates a reaction mechanism for forming a vinyl ester copolymer. In particular, diglycidyl ether of bisphenol A according to formula (XIII) is mixed with methacrylic acid according to formula (XIV) which, in the presence of heat and an AMC-2 initiator, forms a vinyl ester copolymer according to formula (XV).

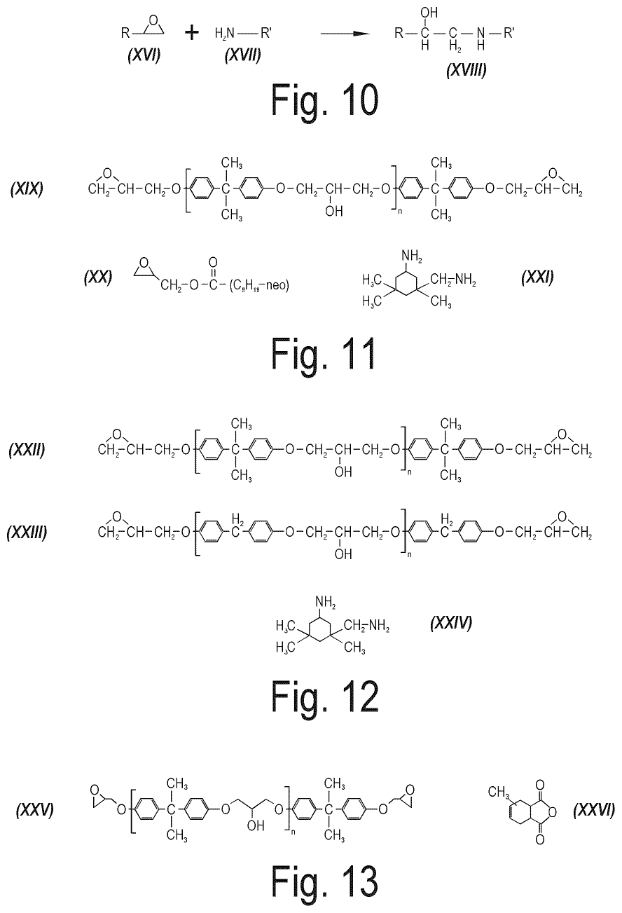

FIG. 10 illustrates a general reaction mechanism of reacting an epoxide according to formula (XVI) with an amine according to formula (XVII), thereby forming an amide bound in the compound according to formula (XVIII).

FIG. 11 illustrates a reaction mixture for forming an epoxide copolymer. In particular, a first component A comprises a mixture of diglycidyl ether of bisphenol A according to formula (XIX) and glycidyl ester of neodecanoic acid according to formula (XX), which may be reacted with a component B comprising a hardener based on isophorone diamine according to formula (XXI) for forming an epoxide copolymer.

FIG. 12 illustrates a reaction mixture for forming an epoxide copolymer. In particular, a first component A comprises a mixture of diglycidyl ether of bisphenol A according to formula (XXII) and diglycidyl ether of bisphenol F according to formula (XXIII), which may be reacted with a component B comprising a hardener based on isophorone diamine according to formula (XXIV) for forming an epoxide copolymer.

FIG. 13 illustrates a reaction mixture for forming an epoxide copolymer. In particular, a diepoxide according to formula (XXV) may be reacted with a component according to formula (XXVI) for forming an epoxide copolymer.

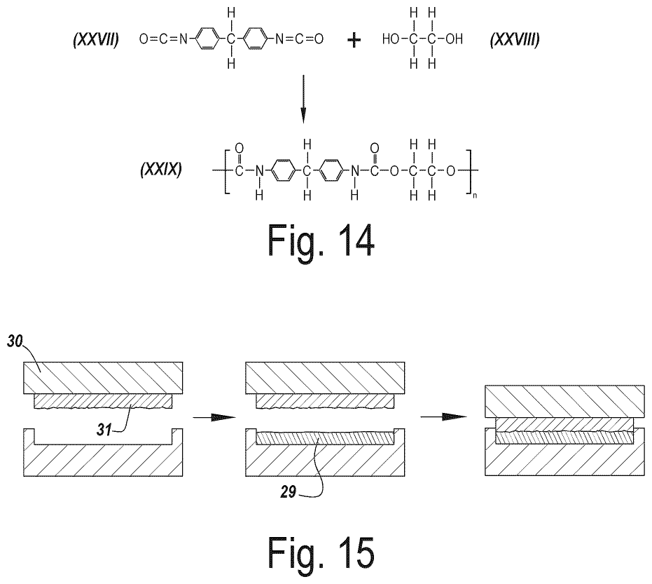

FIG. 14 illustrates a reaction mechanism for forming a polyurethane copolymer. In particular, methylene diphenyl diisocyanate according to formula (XXVII) is mixed with ethylene glycol according to formula (XXVIII), which yields a polyurethane copolymer according to formula (XXIX).

FIG. 15 illustrates some steps in a molding process following the method for manufacturing a decorative panel according to the invention. The method comprises at least the step of providing a substrate comprising a copolymer. Said copolymer is provided by shaping and curing a mixture 29 into at least a part of said substrate. Preferably said mixture 29 further comprises filler materials, reinforcement fibers, metal salt and organic peroxide. Said shaping and curing is executed by introducing the obtained mixture in a press 30 and pressing said mixture 29 at a pressure of for example 1 MPa or above. In the represented example, said press 29 comprises a structured press element 31 which forms at least part of said substrate to have a board shape with a decorative relief in at least one of the major surfaces of said board. A decorative surface may be provided both above or below the mixture to allow directly adhering the substrate and the decorative surface to one another during curing. It may be that the mold comprises structures for directly providing coupling means to the substrate of the decorative panel.

The present invention is in no way limited to the above described embodiments, but such decorative panels and methods may be realized according to several variants without leaving the scope of the invention.

1.-111. (canceled)

112. A decorative panel comprising a substrate and a decorative surface, wherein said substrate comprises an acrylic copolymer.

113. The decorative panel according to claim 112, wherein said copolymer is a copolymer of at least two acrylic compounds.

114. The decorative panel according to claim 113, wherein said at least two acrylic compounds are selected from the group consisting of methyl acrylate, methyl methacrylate, polymethyl methacrylate, ethylene glycol dimethacrylate, or combinations thereof.

115. The decorative panel according to claim 112, wherein said substrate further comprises at least 3 weight parts filler materials per part of the copolymer.

116. The decorative panel according to claim 112, wherein said substrate further comprises at least 5 wt. %, reinforcement fibers.

117. The decorative panel according to claim 116, wherein said reinforcement fibers show one or a combination of two or more of the following properties:
the property that said reinforcement fibers are chosen from the list consisting of glass fibers, rock fibers, basalt fibers, polyvinyl alcohol fibers, copolymer fibers, steel fibers, aramid fibers, polyethylene fibers and carbon fibers;
the property that said reinforcement fibers have a tensile strength above 2500 MPa and/or a Young's modulus of more than 40 GPa;
the property that said reinforcement fibers have an average length of 1 mm or more; and/or
the property that said reinforcement fibers have a diameter situated between 1 and 100 micrometers.

118. The decorative panel according to claim 116, wherein said reinforcement fibers are coated with an adherence promotor.

119. The decorative panel according to claim 112, wherein said decorative surface comprises a printed carrier sheet selected from a printed paper sheet, a printed PVC film, a printed PP film, a printed PE film, a printed PET film, a printed PETG film.

120. The decorative panel according to claim 112, wherein said decorative surface comprises a low temperature glaze, or a curable acrylic resin.

121. The decorative panel according to claim 112, wherein said decorative surface comprises a stone veneer layer.

122. The decorative panel according to claim 112, wherein said substrate further comprises one or more core elements, said core elements comprise a material selected from the group consisting of stone slabs, ceramics slabs, magnesium oxide based slabs, foamed polymer slabs, or combinations thereof.

123. The decorative panel according to claim 112, wherein said decorative panel at two or more opposite edges, is provided with coupling means or coupling parts, with which two of such decorative panels can be coupled at the respective edges, such that they are locked together in a horizontal direction perpendicular to the respective edge and in the plane of the decorative panels, as well as in a vertical direction perpendicular to the plane of the decorative panels.

124. A method for manufacturing a decorative panel, wherein said decorative panel comprises a substrate and a decorative surface, wherein said method comprises at least the step of providing a substrate comprising an acrylic copolymer.

125. The method according to claim 124, wherein said step of providing a substrate comprises:
providing a mixture by mixing at least two acrylic compounds, selected from the group consisting of methyl acrylate, methyl methacrylate, polymethyl methacrylate, ethylene glycol dimethacrylate, or combinations thereof; and
shaping and curing said mixture into at least a part of said substrate.

126. The method according to claim 125, wherein said mixture further comprises an initiator compound, 0.1 to 10 wt. % of an organic peroxide, and/or 0.1 to 10 wt. % of cobalt octonate.

127. The method according to claim 125, wherein said mixture further comprises an activator compound, 0.1 to 10 wt. % of a tertiary amine.

128. The method according to claim 125, wherein said mixture further comprises a coupling agent, 0.1 to 10 wt. % of a silane and/or 0.1 to 10 wt. % of a zirconate.

129. The method according to claim 125, wherein said substrate further comprises at least 3 weight parts filler materials per part of the copolymer.

130. The method according to claim 125, wherein said substrate further comprises at least 5 wt. %, reinforcement fibers.

131. The method according to claim 130, wherein said reinforcement fibers show one or a combination of two or more of the following properties:
the property that said reinforcement fibers are chosen from the list consisting of glass fibers, rock fibers, basalt fibers, polyvinyl alcohol fibers, copolymer fibers, steel fibers, aramid fibers, polyethylene fibers and carbon fibers;
the property that said reinforcement fibers have a tensile strength above 2500 MPa and/or a Young's modulus of more than 40 GPa;
the property that said reinforcement fibers have an average length of 1 mm or more; and/or
the property that said reinforcement fibers have a diameter situated between 1 and 100 micrometers.
